(19) United States
(12) Patent Application Publication
(10) Pub. No.: US 2025/0118512 A1
(43) Pub. Date: Apr. 10, 2025

(54) TEMPERATURE-DEPENDENT SWITCH

(71) Applicant: Marcel P. Hofsaess, Steintahleben (DE)

(72) Inventor: Marcel P. Hofsaess, Steintahleben (DE)

(21) Appl. No.: 18/902,368

(22) Filed: Sep. 30, 2024

(30) Foreign Application Priority Data
Oct. 10, 2023 (DE) 10 2023 127 594.1

(51) Int. Cl. H01H 37/54; H01H 1/58

(52) U.S. Cl. CPC H01H 37/5427; H01H 37/5409; H01H 1/58

(57) ABSTRACT

A temperature-dependent switch comprising a switch housing, a temperature-dependent switching mechanism, and a spacer element. The temperature-dependent switching mechanism is arranged in the switch housing and comprises a movable contact part, a bimetal element and a spring element. The switching mechanism is configured to switch between a low-temperature state, in which an electrical connection is established between first and second electrical terminals, and a high-temperature state, in which the electrical connection between the first and second electrical terminals is interrupted. The spacer element is arranged inside the switch housing between a lower part and a cover part. At least one section of the spring element is arranged between the spacer element and the switch housing and is fixed in position. At least one section of the bimetal element is arranged between the spring element and the spacer element and is supported on the spacer element in the high-temperature state.

### CROSS-REFERENCE TO RELATED APPLICATIONS

This application claims priority from German patent application DE 10 2023 127 594.1 filed on Oct. 10, 2023. The entire contents of this priority application are incorporated herein by reference.

### FIELD

This disclosure relates to a temperature-dependent switch.

Exemplary temperature-dependent switches are disclosed in DE 10 2013 109 291 A1 and DE 10 2011 119 637 B4.

Such temperature-dependent switches are used in a principally known manner to monitor the temperature of a device. For this purpose, the switch is brought into thermal contact with the device to be protected, e.g. via one of its outer surfaces, so that the temperature of the device to be protected influences the temperature of the switching mechanism arranged inside the switch.

The switch is typically connected electrically in series into the supply circuit of the device to be protected via connecting cables, so that below the response temperature of the switch, the supply current of the device to be protected flows through the switch.

In the switch disclosed in DE 10 2013 109 291 A1, the switching mechanism is arranged inside a switch housing. The switch housing is a closed housing in which the switching mechanism is sealed against the outside. The switch housing is formed in two parts. It comprises a lower part which is closed by a cover part. The cover part is fixed to the lower part. For this purpose, the lower part comprises a raised, circumferential edge, the free, upper edge of which is bent or flanged onto the cover part.

The temperature-dependent switching mechanism arranged in the switch housing comprises a spring element, to which a movable contact part is fixed, and a bimetal element that interacts with the movable contact part. The spring element presses the movable contact part against a stationary counter contact arranged on the inside of the switch housing on the cover part. The outer edge of the spring element, which is configured as a snap-action spring disc, is supported in the lower part of the switch housing so that the electric current flows from the lower part through the snap-action spring disc and the movable contact part into the stationary counter contact and from there into the cover part.

A temperature-dependent bimetal element, which in the switches disclosed in DE 10 2013 109 291 A1 and DE 10 2011 119 637 B4 has a disc-shaped design and is often referred to as a bimetal snap-action disc, is essentially responsible for the temperature-dependent switching behavior of the switching mechanism. This bimetal element is usually configured as a multi-layer, active, sheet-shaped device composed of two, three or four interconnected components with different thermal expansion coefficients. The connection of the individual metal or metal alloy layers in bimetal elements of this type is usually a material-locking or positive locking connection and is achieved, for example, by rolling.

Such a bimetal element has a first stable geometric configuration (low-temperature configuration) at low temperatures, below the response temperature of the bimetal element, and a second stable geometric configuration (high-temperature configuration) at high temperatures, above the response temperature of the bimetal element. The bimetal element snaps from its low-temperature configuration to its high-temperature configuration in a temperature-dependent manner in the manner of a hysteresis.

Thus, if the temperature of the bimetal element rises above the response temperature of the bimetal element as a result of a temperature increase in the device to be protected, the bimetal element snaps from its low-temperature configuration to its high-temperature configuration. Thereby, the bimetal element works against the spring element in such a way that it lifts the movable contact part from the stationary counter contact, so that the switch opens and the device to be protected is switched off and cannot heat up any further.

Unless a reset lock is provided, the bimetal element snaps back to its low-temperature configuration so that the switch is closed again as soon as the temperature of the bimetal element drops below the so-called reset temperature of the bimetal element as a result of cooling of the device to be protected.

In its low-temperature configuration, the bimetal element is preferably mounted in the switch housing in a mechanically force-free manner, wherein the bimetal element is also not used to carry the current. This has the advantage that the bimetal element has a longer service life and that the switching point, i.e. the response or switching temperature of the bimetal element, does not change even after many switching cycles.

In the switches disclosed DE 10 2013 109 291 A1 and DE 10 2011 119 637 B4, the spring element configured as a snap-action spring disc is, in the area of its outer edge, in permanent contact with the lower part. In the switch disclosed in DE 10 2011 119 637 B4, part of the outer edge of the snap-action spring disc is connected to the lower part of the switch housing in a material-locking manner. In the switch disclosed in DE 10 2013 109 291 A1, the snap-action spring disc rests on a circumferential shoulder provided in the lower part and is clamped between this shoulder and a spacer element configured as a spacer ring, thereby being mechanically fixed. In both cases, the snap-action spring disc is therefore permanently galvanically connected to the current-carrying switch housing both in the low-temperature state of the switching mechanism and in the high-temperature state of the switching mechanism.

The permanent galvanic connection of the snap-action spring disc with the current-carrying lower part of the switch housing ensures that the contact resistance between the snap-action spring disc and the lower part of the switch housing is very low. In this way, a possible source of error is eliminated that can occur during the final continuity test of a fully assembled temperature-dependent switch. It is possible that, due to manufacturing tolerances, the contact resistance between the lower part of the housing and the snap-action spring disc is so high that the finished temperature-dependent switch must be discarded as a reject.

Conversely, most switches known from the prior art are provided with spring elements whose edge rests loosely, i.e. freely movably, on the inner base of the lower part of the switch housing or on a shoulder extending circumferentially inside the lower part. Such a switch is disclosed in, for example, DE 43 45 350 A1. It is understood that such a loosely supported spring element has significantly more mechanical degrees of freedom, so that the spring element can move more freely within the switch housing when the switching mechanism snaps from the low-temperature state and the high-temperature state (and vice versa). This has a fundamentally positive effect on the service life of the switching mechanism and the long-term consistency of its switching temperature. However, the permanent galvanic connection between the spring element and the current-carrying switch housing, which is not provided for here, results in the above-mentioned disadvantages, i.e. in particular increased rejects and increased contact resistance.

### SUMMARY

It is an object to provide a temperature-dependent switch in which the above-mentioned disadvantages are prevented or at least reduced as far as possible in a structurally simple way. In this respect, it is in particular an object to provide a switch composed of as few components as possible, which is easy to install and whose service life and/or switching capacity can be increased compared to the temperature-dependent switches known to date.

According to an aspect, a temperature-dependent switch is provided, comprising:
a switch housing having a lower part and a cover part closing the lower part;
a temperature-dependent switching mechanism which is arranged in the switch housing and comprises a movable contact part, a bimetal element and a spring element interacting with the movable contact part, wherein the switching mechanism is configured to switch in a temperature-dependent manner between a low-temperature state, in which the switching mechanism presses the movable contact part against a contact surface arranged inside of the switch housing to establish an electrical connection between a first electrical terminal of the switch and a second electrical terminal of the switch, and a high-temperature state, in which the switching mechanism keeps the movable contact part spaced apart from the contact surface to interrupt the electrical connection between the first electrical terminal and the second electrical terminal; and
a spacer element arranged inside the switch housing between the lower part and the cover part;
wherein at least one section of the spring element is arranged between the spacer element and the switch housing and is fixed in position by an interaction of the spacer element and the switch housing, and
wherein at least one section of the bimetal element is arranged between the spring element and the spacer element and is supported on the spacer element in the high-temperature state of the switching mechanism.

The spring element of the temperature-dependent switching mechanism is fixed in its position by a spacer element arranged inside the switch housing. More precisely, the spring element is fixed in its position by an interaction of the spacer element and the switch housing. This means that both the spacer element and the switch housing contribute to fixing the position of the spring element. Both the spacer element and the switch housing exert a force on the spring element, fixing it in position. There can, but does not necessarily have to be, direct contact between the spacer element and the spring element on the one hand and between the switch housing and the spring element on the other. The switch housing and spacer element can also be indirectly connected to the spring element.

The spacer element fulfills several functions simultaneously. It fulfills the already known two functions, namely that it is configured to keep the lower part and the cover part spaced apart from one another, and that it is configured to fix the spring element in its position. The spring element additionally fulfills a third function, namely that it serves as an abutment on which the bimetal element can be supported in the high-temperature state of the switching mechanism.

Thus, by means of a single component in the form of a spacer element, several functions can be fulfilled at the same time. This not only simplifies the structural design of the switch, but also its assembly. The latter additional function of the switch as an abutment for the bimetal element also has a positive effect on the service life of the switch.

In the switches cited above, the bimetal element in its high temperature state is typically supported either on the spring element itself or on the cover part of the switch housing. Supporting it on the spring element has the disadvantage that it is subject to high mechanical stress and can be damaged, in particular after many switching cycles. In contrast, support on the cover part of the switch housing is less problematic, but requires on the one hand that the switching mechanism is very precisely adapted to the manufacturing tolerances of the housing components and on the other hand that the bimetal element in its high-temperature configuration usually has to bend very strongly until it reaches the cover part with its outer edge and presses down the movable contact part with its center.

However, by using the abutment provided on the spacer element, the manufacturing tolerances of the switching mechanism are now largely independent of the manufacturing tolerances of the switch housing. In addition, the bimetal element only has to bend slightly, as the spacer element can be arranged very close to it and the spring element. Mechanical wear on the spacer element is also harmless, as it can be configured to be much more stable than the spring element, for example.

The above-mentioned advantages resulting from the permanent galvanic connection between the spring element and the current-carrying switch housing can also be realized by means of the spacer element.

While the spring element is supported on the spacer element in the high-temperature state of the switching mechanism, the spring element is preferably spaced apart from the spacer element in the low-temperature state of the switching mechanism. The spring element therefore does not touch the spacer element in the low-temperature state of the switch.

In a refinement, the at least one section of the spring element, which is arranged between the spacer element and the switch housing and is fixed in position by an interaction of the spacer element and the switch housing, comprises an outer edge of the spring element.

In other words, the spring element is preferably fixed in its position on the edge side by the interaction of the spacer element and the switch housing. Particularly preferably, the at least one section of the spring element comprises a radially outer edge of the spring element. This has the advantage of a space-saving, edge-side mounting of the spring element, while the central area of the spring element is freely accessible for the switching mechanism.

In a further refinement, the at least one section of the bimetal element, which is arranged between the spring element and the spacer element and is supported on the spacer element in the high-temperature state of the switching mechanism, comprises an outer edge of the bimetal element.

In other words, the outer edge of the bimetal element rests against the spacer element in the high-temperature state of the switching mechanism. In the low-temperature state of the switching mechanism, this outer edge is preferably spaced apart from the spacer element. This also makes it possible to arrange the switching mechanism in the most space-saving way possible. In addition, the spacer element can be placed on the radially outer edge of the switching mechanism to save space without interfering with the other components of the switching mechanism.

In a further refinement, the at least one section of the spring element arranged between the spacer element and the switch housing is (i) clamped directly or indirectly between the spacer element and the lower part or (ii) clamped directly or indirectly between the spacer element and the cover part.

Such a clamping arrangement between the spacer element and the lower part or between the spacer element and the cover part is particularly easy for realizing the position fixing of the spring element. The spring element can thus be simply inserted into the interior of the switch housing at the desired position during assembly of the switch, the spacer element can be placed on top or underneath and the switch housing can then be closed by fixing the cover part to the lower part or vice versa. The position of the spring element is then fixed automatically as soon as the cover part is fixed to the lower part. This does not require any additional effort in the assembly process.

With “indirectly clamped”, the present term means that the spring element is clamped by the spacer element and the lower part or the spacer element and the cover part, but it does not necessarily have to be in direct contact with these two components. Furthermore, housing components or elements can be arranged in between. In particular, for example, an insulating foil or other intermediate layer can be arranged between the aforementioned components.

In a further refinement, the spacer element comprises a spacer ring.

The spacer element is preferably configured as a spacer ring. The spacer element can therefore be configured as a standard device. Additional costs are not incurred by the provision of the spacer element or, if at all, only slightly. The spacer element itself can be made of an electrically conductive material (e.g. metal) or an electrically non-conductive material (e.g. plastic).

In a further refinement, the spacer element has a substantially L-shaped cross-section.

With an “substantially L-shaped cross-section”, the present term means that the cross-sectional area of the spacer element comprises a shape that is at least similar to an L-shape. Preferably, the shape of the cross-sectional area corresponds to an L-shape

In a further refinement, a first side of the spring element facing the bimetal element faces the contact surface.

The bimetal element is thus arranged on the same side of the spring element on which the contact surface of the stationary counter contact is arranged. If the contact surface of the stationary counter contact is arranged above the spring element, the bimetal element is also arranged above the spring element. If, on the other hand, the contact surface of the stationary counter contact is arranged below the spring element, the bimetal element is also arranged below the spring element. This has the advantage that the bimetal element and the spring element can be curved in the same direction both in the low-temperature state of the switching mechanism and in the high-temperature state of the switching mechanism. In the high-temperature state of the switching mechanism, the center of the bimetal element can, for example, press directly against a central area of the spring element in order to lift the movable contact part off the contact surface of the stationary counter contact.

In a further refinement, the spacer element projects in a first direction from the first side of the spring element and comprises a support surface on which the at least one section of the bimetal element is supported in the high-temperature state of the switching mechanism, wherein the support surface is oriented transversely, preferably orthogonally, to the first direction.

In the present case, the term “transverse” does not necessarily mean an orthogonal or perpendicular orientation. Instead, it is understood to mean any type of orientation that is not parallel. Thus, an oblique orientation at an angle not equal to 0° also falls under the term “transverse”.

In the low-temperature state of the switching mechanism, the at least one section of the bimetal element is preferably spaced apart from the support surface.

By the described, essentially L-shaped cross-sectional shape of the spacer element, it can very easily act as a kind of retaining claw, against which the bimetal element can be supported on the edge in the high-temperature state of the switching mechanism. At the same time, the spacer element preferably stores flat on the spring element and acts as a hold-down device for the spring element, by means of which the spring element is fixed in its position within the switch housing.

In a further refinement, the spacer element is clamped in the switch housing by an interaction of the lower part and the cover part.

This has the advantage that the spacer element is automatically fixed in its position after the switch housing is closed. This also automatically fixes the at least one section of the spring element in its position after the switch housing is closed. The spacer element can be clamped directly or indirectly between the lower part and the cover part. If both the lower part and the cover part as well as the spacer element are made of an electrically conductive material, an insulating element, preferably in the form of an insulating foil, is arranged at least between the spacer element and the lower part or between the spacer element and the cover part.

In a further refinement, the spring element comprises between an outer edge and an inner area at least one compensating section, which is configured to be resilient in the radial direction and enables mechanical deformation of the spring element.

The at least one compensating section has the advantage that it compensates for or at least reduces internal deformations that can occur due to the clamping of the spring element on the edge side when the switching mechanism is shifted. Such internal deformations and the internal forces thereby occurring would otherwise lead to mechanical stress and ageing of the spring element, which would limit the service life of the switches equipped with it.

Such a “compensation section” is thus understood in the present case to be an area of the spring element that is configured to yield or be flexible in the radial direction and enables a radial evasive or expansion movement within the spring element, although the outer edge of the spring element is firmly clamped and can therefore not move in the radial direction, or at least only very slightly. A compensating section can therefore also be referred to as an expansion structure.

In a further refinement, the movable contact part is fixed to the spring element in a material-locking manner.

For example, the movable contact part is soldered or welded to the spring element. This enables simple and inexpensive assembly of the switching mechanism because the contact part cannot slip during assembly. Preferably, the movable contact part is arranged in a central, middle area of the spring element.

In a further refinement, the bimetal element is held captive but with play on the movable contact part (and the spring element).

This means that the spring element, the bimetal element and the movable contact part form a unit, so that the switching mechanism can be assembled and temporarily stored as a separate semi-finished part. It is also possible to check the switching mechanism separately, as the bimetal element is held captive on the movable contact part, but with play, i.e. correspondingly loose, and can therefore deform unhindered between its low-temperature configuration and its high-temperature configuration.

In a further refinement, the bimetal element and the spring element are each essentially disc-shaped and the movable contact part is fixed centrally on the spring element. In a particularly preferred embodiment, both the spring element and the bimetal element are each circular disc-shaped.

In a further refinement, the first electrical terminal of the switch is arranged on the outside of the cover part and the second electrical terminal of the switch is arranged on the outside of the lower part.

This ensures that the temperature-dependent switch is easy to connect electrically.

In a further refinement, the lower part comprises a free upper edge which is flanged or bent onto the cover part.

This results in the simplest and most stable possible type of fixation between the lower part and the cover part, as is known, for example, from DE 10 2013 109 291 A1.

It is to be understood that the features mentioned above and those to be explained below can be used not only in the combination indicated in each case, but also in other combinations or on their own, without departing from the spirit and scope of the present disclosure.

### BRIEF DESCRIPTION OF THE DRAWINGS

FIG. 1 shows a schematic sectional view of the temperature-dependent switch according to a first embodiment, wherein the switch is in its low-temperature state.

FIG. 2 shows a schematic sectional view of the temperature-dependent switch shown in FIG. 1, wherein the switch is in its high-temperature state.

FIG. 3 shows a schematic sectional view of the temperature-dependent switch according to a second embodiment, wherein the switch is in its low-temperature state.

FIG. 4 shows a schematic sectional view of the temperature-dependent switch according to a third embodiment, wherein the switch is in its low-temperature state.

FIG. 5 shows a schematic sectional view of the temperature-dependent switch according to a fourth embodiment, wherein the switch is in its low-temperature state.

FIG. 6 shows a schematic sectional view of the temperature-dependent switch according to a fifth embodiment, wherein the switch is in its low-temperature state.

### DESCRIPTION OF PREFERRED EMBODIMENTS

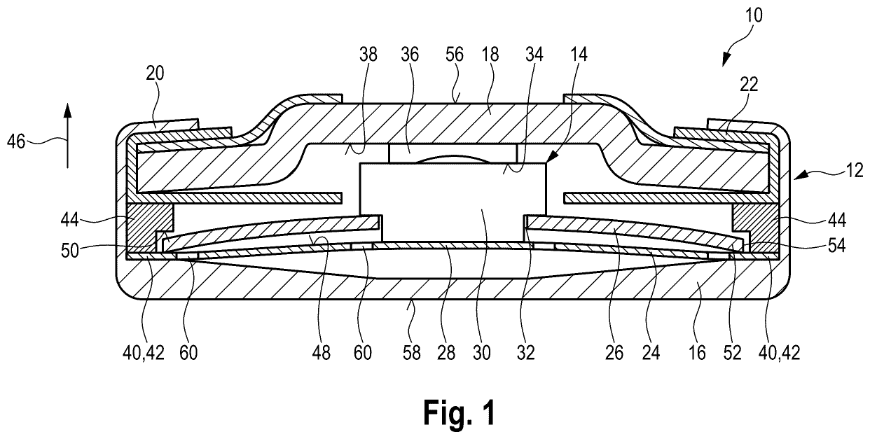

FIGS. 1-6 show five different embodiments of the switch, each in a schematic sectional view. In each case, the switch is denoted in its entirety by reference numeral 10.

The switch 10 is configured to be rotationally symmetrical and has a circular shape when viewed from above. The switch 10 comprises a switch housing 12 in which a temperature-dependent switching mechanism 14 is arranged. The switch housing 12 comprises a pot-like lower part 16, which is closed by a cover part 18. The lower part 16 comprises a raised edge 20, which is bent or flanged inwards in the area of its free upper end and thereby clamps or fixes the cover part 18 to the lower part 16 with an insulating foil 22 interposed.

The lower part 16 as well as the cover part 18 are made of an electrically conductive material, preferably metal. In the herein shown embodiment, the lower part 16 is a deep-drawn steel housing, which results in a comparatively high pressure resistance. The insulating foil 22 is arranged between the lower part 16 and the cover part 18, which serves to electrically insulate the two switch housing components 16, 18.

The cover part 18 completely closes the lower part 16. In addition to the electrical insulation, the insulating foil 22 also ensures a sufficient mechanical seal between the lower part 16 and the cover part 18, so that the interior of the switch housing 12 is sealed off from the outside. This prevents liquids or impurities from entering the interior of the housing from the outside.

The switching mechanism 14 arranged inside the switch housing comprises a temperature-independent spring element 24 and a temperature-dependent bimetal element 26. The spring element 24 is preferably designed as a circular disc-shaped snap-action spring disc.

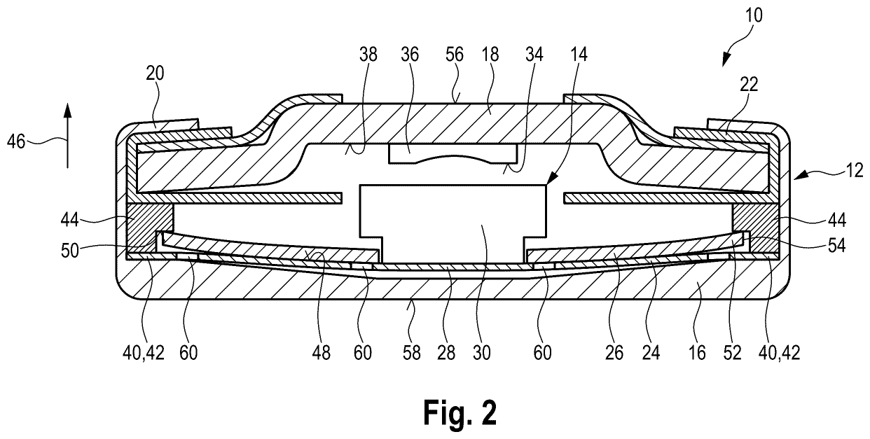

The temperature-dependent bimetal element 26 is preferably designed as a bimetallic disc, which comprises two temperature-dependent configurations, a geometric low-temperature configuration (see FIG. 1) and a geometric high-temperature configuration (see FIG. 2). In the area of the center 28 of the spring element 24, a contact part 30 is fixed to the spring element 24. This contact part 30 is connected to the spring element 24 in a material-locking manner. For example, the contact part 30 is welded or soldered to the spring element 24. Since the contact part 30 moves with the spring element 24 relative to the switch housing 12 during a switching operation, the contact part 30 is also referred to as a “moving contact part”.

The bimetal element 26 is held captive, but with play, on the movable contact part 30. A through hole 32 provided centrally in the bimetal element 26 has an inner diameter which is slightly larger than an outer diameter of the movable contact part 30 which is provided in the lower area. However, since the outer diameter of the movable contact part 30 in its upper area is larger than this inner diameter of the through hole 32 and the spring element 24 is arranged below the bimetal element 26 and is firmly connected to the movable contact part 30, the bimetal element 26 cannot unintentionally detach from the switching mechanism 14 despite its freedom of movement. The spring element 24, the bimetal element 26 and the movable contact part 30 thus illustrate a captive unit of the switching mechanism 14, which can be pre-produced as a semi-finished product and inserted as a whole into the switch housing 12 during assembly of the switch 10.

In the low-temperature state of the switching mechanism 14 shown in FIG. 1, the spring element 24 presses the movable contact part 30 against a contact surface 34, which is arranged on the underside of a stationary contact part 36. In the embodiment shown in FIG. 1, the stationary contact part 36 is arranged on a bottom side 38 of the cover part 18 facing the lower part 16.

In the area of its radially outer edge 40, the spring element 24 is fixed in the switch housing 12. More precisely, a radially outer section 42, which forms the outer edge 40 of the spring element 24, is clamped between a spacer element 44 and the lower part 16 of the switch housing 12 in the embodiment shown in FIG. 1. The spacer element 44 itself is also clamped in the switch housing 12 between the lower part 16 and the cover part 18. The spacer element 44 is clamped indirectly between the lower part 16 and the cover part 18 and arranged directly between the spring element 24 and the insulating foil 22.

When assembling the switch 10 shown in FIG. 1, the switching mechanism 14 is first inserted into the lower part 16. The spacer element 44 is then placed on the outer edge section 42 of the spring element 24 and then the cover part is placed on the spacer element 44 with the insulating foil 22 in between. Finally, the upper, upstanding edge 20 of the lower part is bent or flanged inwards, whereby the cover part 18 is pressed from above onto the spacer element 44, wherein the latter in turn presses onto the spring element 24, whereby the spring element 24 is fixed in position in the switch housing 12. It will be understood that the positional fixation only affects the outer edge portion 42 of the spring element 24, but the central area 28 of the spring element 24 together with the movable contact part 30 is still movable within the switch housing 12.

The spacer element 44 is configured as a spacer ring which has an essentially L-shaped cross-section. This spacer ring 44 protrudes from a first side 48 of the spring element 24 in a first direction, which corresponds here to the vertical direction and is schematically indicated in FIG. 1 with the arrow 46. This first side 48 of the spring element 24 is the (upper) side of the spring element 24 that faces the bimetal element 26 and the contact surface 34.

The spacer element 44 further comprises a support surface 50, which is oriented transversely to the first direction 46 and faces the bimetal element 26.

An outer section 52 comprising an outer edge 54 of the bimetal element 26 is arranged between the spring element 24 and the spacer element 44. More specifically, this section 52 of the bimetal element 26 is arranged between the support surface 50 and the spring element 24. With this outer section 52, the bimetal element 26 is in the high-temperature state of the switching mechanism 14 supported on the spacer element 44 or on the support surface 50 arranged thereon (see FIG. 2).

In the closed switching position of the switch 10 shown in FIG. 1, in which the switching mechanism 14 is in its low-temperature state, the spring element 26 thus presses the movable contact part 30 against the contact surface 34 arranged on the stationary contact part 36. Since the spring element 24 with its outer edge section 42 is in permanent galvanic contact with the lower part 16, the switching mechanism 14 thus establishes in the low-temperature state shown in FIG. 1 an electrically conductive connection between a first terminal 56 and a second terminal 58. The first terminal 56 is, for example, the outer side of the cover part 18. If the cover part 18 is not made entirely of metal, only a part of it can be made of metal or an electrically conductive material, wherein this part is connected to the stationary contact part 36 and is guided to the outside. For example, a shoot-through contact can be arranged in the cover part 18 above the stationary contact part 36, as is known, for example, from DE 103 01 803 B4. In the switch 10 shown in FIG. 1, an outer side of the lower part 16 preferably functions as the second terminal 58.

In the low-temperature state of the switch 10, an electric current can thus flow from the first terminal 56 through the cover part 18 into the stationary contact part 36 and from there via the movable contact part 30, the spring element 24 into the lower part 16 and thus ultimately to the second terminal 58 (or vice versa). In this low-temperature state of the switch 10, the bimetal element 26 is stored in a more or less force-free manner.

If, starting from the situation shown in FIG. 1, the temperature of the apparatus to be monitored by the switch 10 and thus also the temperature of the switch 10 and the switching mechanism 14 used therein rises above a response temperature of the bimetal element 26, the bimetal element 26 snaps from its low-temperature configuration shown in FIG. 1 to its high-temperature configuration shown in FIG. 2. The upper side of the bimetal element 26 thereby snaps from a convex curvature to a concave curvature. The bimetal element 26 is then supported from below with its outer edge section 52 on the support surface 50 of the spacer element 44. At the same time, the bimetal element 26 presses the movable contact part 30 downwards with its center and lifts it off the contact surface 34. During this switching movement, the bimetal element 26 exerts a force that acts against the force exerted on the contact part 30 by the spring element 24 in the low-temperature state. As a result, the spring element 24 also snaps from its first convex shape on the upper side shown in FIG. 1 into its concave shape on the upper side as shown in FIG. 2.

This interrupts the current flow through the switch 10. The switch is thus open.

In order to give the spring element 24 the possibility of being able to expand mechanically at the time of snapping over from the situation shown in FIG. 1 to the situation shown in FIG. 2 despite its edge-side clamping, the spring element 24 preferably has several compensating sections 60. These compensation sections 60 enable the spring element 24 to expand and compress in a radial direction, which in particular prevents internal tension or deformation of the spring element 24. The compensating sections 60 can have a similar design to that disclosed in DE 10 2013 109 291 A1.

A further advantage of the fixed clamping of the outer edge 40 of the spring element 24 is that the permanent mechanical and electrical connection between the spring element 24 and the switch housing 12 means that sparks and/or arcing cannot occur during a switching operation, as is often the case with switching mechanisms in which the edge of the spring element lifts off the switch housing during the switching operation. This can effectively prevent a contact burn-off.

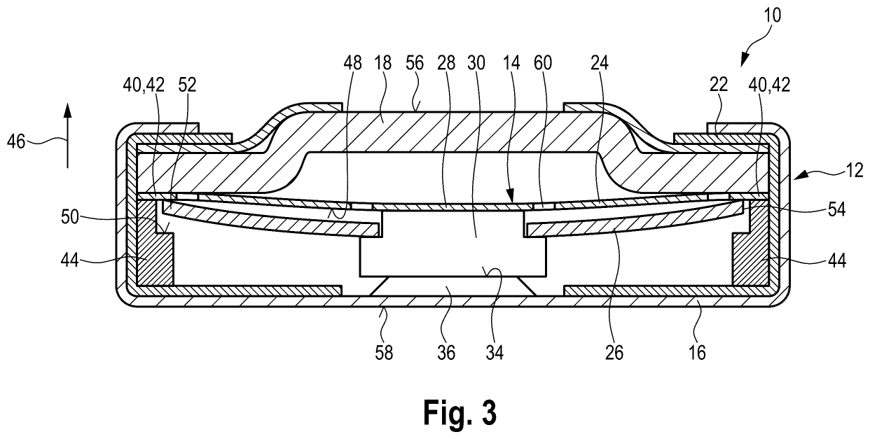

FIG. 3 shows a second embodiment of the switch 10 in a schematic sectional view. Here, the low-temperature state of the switch 10 is shown again, in which the switching mechanism 14 establishes the electrically conductive connection between the first terminal 56 and the second terminal 58. The switching mechanism 14 has the same basic structure here as in the first embodiment. However, it is inserted into the switch housing 12 rotated by 180°, so to speak “upside down”.

The spring element 24 is arranged with its edge section 42 clamped between the cover part 18 and the spacer element 44. The spacer element 44 is again arranged clamped in the switch housing 12 between the lower part 16 and the cover part 18, wherein, according to this second embodiment, it is now clamped between the spring element 24 and the lower part 16 with the insulating foil 22 interposed.

The spacer element 44 again has a substantially L-shaped cross-section and comprises a support surface 50 against which the bimetal element 26 in its high-temperature configuration can be supported with its outer edge portion 52. The first side 48 of the spring element 24 also faces both the bimetal element 26 and the contact surface 34. However, the first side 48 of the spring element 24 points downwards here. However, according to this embodiment, the stationary contact part 36 with the contact surface 34 arranged thereon is no longer arranged on the cover part 18, but now on the lower part 16.

However, the general switching behavior of the switching mechanism 14 does not change, which is why the high-temperature state of the switch 10 is not shown again in the second embodiment shown in FIG. 3 for the sake of simplicity.

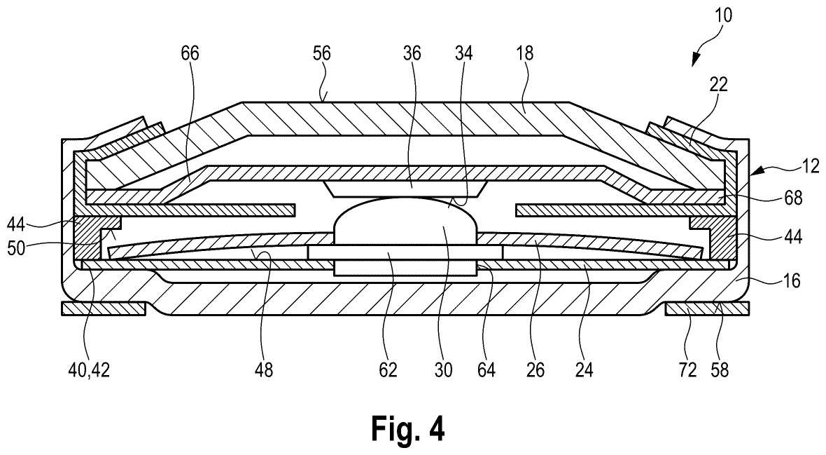

FIG. 4 shows a third embodiment of the switch 10, wherein the switch 10 here is basically constructed in a similar way to the first embodiment shown in FIGS. 1 and 2. The spring element 24 is again clamped with its outer edge section 42 between the spacer element 44 and the lower part 16 of the switch housing 12. However, the switching mechanism 14 is constructed somewhat differently. Here, the first side 48 of the spring element 24 also faces the bimetal element 26 as well as the contact surface 34. Here, however, the bimetal element 26 rests upwardly on a circumferential collar 62 provided on the movable contact part 30. The spring element 24 rests against this collar 62 from the opposite lower side. The movable contact part 30 is not necessarily connected to the spring element 24 in a material-locking manner. Instead, the spring element 24 comprises here a central through opening 64, into which the part of the movable contact part 30 located under the collar 62 is inserted in a positive locking manner.

A further difference to the first embodiment shown in FIGS. 1 and 2 is that the stationary contact part 36 is not arranged on the bottom side 38 of the cover part 18. Instead, in the third embodiment shown in FIG. 4, a contact carrier element 66 is arranged in the switch housing 12, to which the stationary contact part 36 is fixed. The contact carrier element 66 functions as a kind of sub cover, which is clamped between the lower part 16 and the cover part 18. More precisely, the edge 68 of this contact carrier element 66 is clamped between the cover part 18 and the spacer element 44 with the insulating foil 22 interposed.

The contact carrier element 66 is preferably made of an electrically conductive material, for example metal. Particularly preferably, the contact carrier element 66 comprises a thinner wall thickness than the cover part 18 of the switch housing 12 arranged above it.

The main advantage of the additional contact carrier element 66 provided here is that it can be used to compensate for manufacturing tolerances on the switch housing 12 and the switching mechanism 14 in a simple design way. Depending on customer requirements, the contact carrier element 66 configured as a sub cover can be preformed in such a way that a desired contact pressure is achieved in the low-temperature state of the switching mechanism 14. For example, if a high contact pressure is desired between the stationary contact portion 36 and the movable contact portion 30 when a high level of performance is required from the switch 10, a differently shaped contact carrier element 66 can be inserted into the switch housing 12 than when lower levels of performance are required from the switch. In other words, the contact pressure between the switching mechanism 14 and the stationary contact part 36 can be adjusted very easily by means of the contact support element 66, without having to change the switch housing 12 itself for this purpose. It is understood that with the setting of the respective contact pressure, a corresponding setting of the contact resistances between the switching mechanism 14 and the stationary contact part 36 is also automatically made. The fact that this setting can be determined more or less solely by the shape of the contact carrier element 66 offers an enormous cost advantage, as switches can thus be adapted to a wide range of technical specifications without having to change anything on the switching mechanism 14 or the switch housing 12.

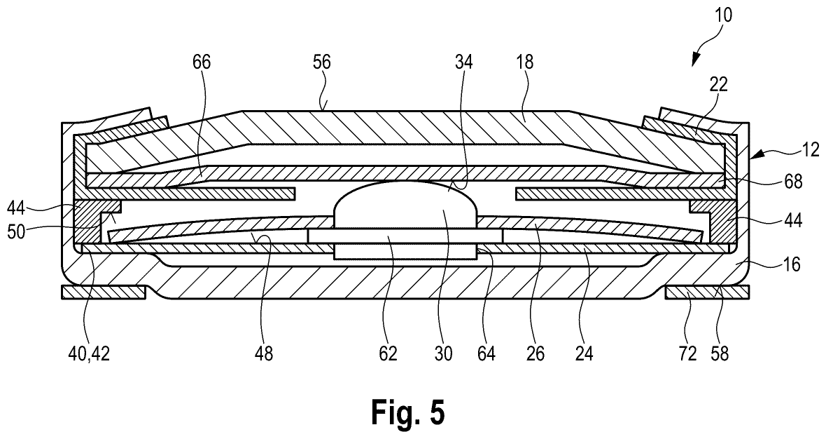

The fourth embodiment of the switch 10 shown in FIG. 5 also follows this principle. Unlike in the embodiment shown in FIG. 4, here only the contact surface 34 is arranged directly on the bottom side of the contact carrier element 66. An extra stationary contact part 36 is omitted.

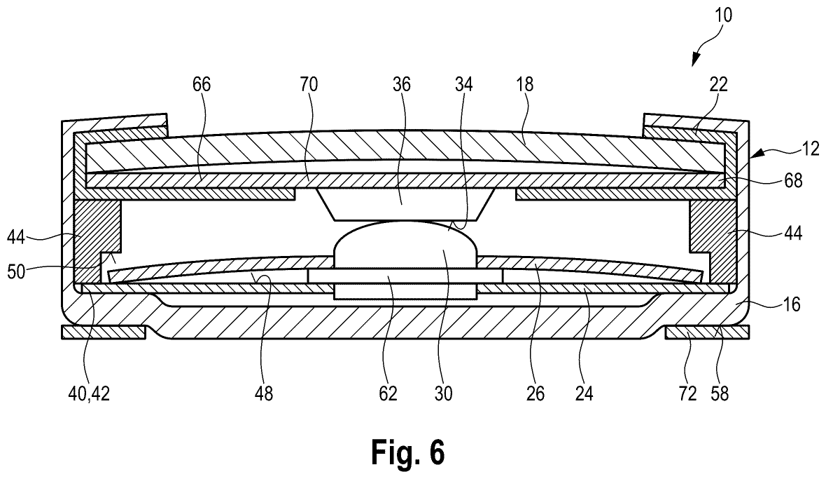

The fifth embodiment shown in FIG. 6 also follows the principle mentioned above. Here, however, the contact carrier element 66 is configured as a second spring element 70, to which the contact part 36 is fixed together with its contact surface 34 arranged thereon. By means of this second spring element 70, the contact pressure between the movable contact part 30 and the contact surface 34 can be further increased, whereby the contact resistance between these two devices can be further reduced. The second spring element 70 exerts a force on the contact part 36 which is opposite to the force exerted by the first spring element 24 on the movable contact part 30.

Finally, with regard to the embodiments shown in FIGS. 4-6, it should also be mentioned that the second terminal 58 of the switch is designed slightly differently here than in the embodiments shown in FIGS. 1-3. This is because the terminal 58 is designed here as an indentation provided in the lower part 16, into which a circumferential connection ring 72 can be inserted, which is preferably welded to the lower part 16. This connection ring 58 can not only function as an electrical connection, but can also be connected to the conveyor belt during the production of the switch 10.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A temperature-dependent switch, comprising:
a switch housing having a lower part and a cover part closing the lower part;
a temperature-dependent switching mechanism which is arranged in the switch housing and comprises a movable contact part, a bimetal element and a spring element interacting with the movable contact part, wherein the switching mechanism is configured to switch in a temperature-dependent manner between a low-temperature state and a high-temperature state, wherein, in the low-temperature state, the switching mechanism presses the movable contact part against a contact surface arranged inside the switch housing to establish an electrical connection between a first electrical terminal of the switch and a second electrical terminal of the switch, and wherein, in the high-temperature state, the switching mechanism keeps the movable contact part spaced apart from the contact surface to interrupt the electrical connection between the first electrical terminal and the second electrical terminal; and
a spacer element arranged inside the switch housing between the lower part and the cover part;
wherein at least one section of the spring element is arranged between the spacer element and the switch housing and is fixed in position by an interaction of the spacer element and the switch housing, and
wherein at least one section of the bimetal element is arranged between the spring element and the spacer element and is supported on the spacer element in the high-temperature state of the switching mechanism.

2. The temperature-dependent switch according to claim 1, wherein the at least one section of the spring element comprises an outer edge of the spring element.

3. The temperature-dependent switch according to claim 1, wherein the at least one section of the bimetal element comprises an outer edge of the bimetal element.

4. The temperature-dependent switch according to claim 1, wherein the at least one section of the spring element is clamped indirectly or directly between the spacer element and the lower part.

5. The temperature-dependent switch according to claim 1, wherein the at least one section of the spring element is clamped indirectly or directly between the spacer element and the cover part.

6. The temperature-dependent switch according to claim 1, wherein the spacer element comprises a spacer ring.

7. The temperature-dependent switch according to claim 1, wherein the spacer element has a L-shaped cross-section.

8. The temperature-dependent switch according to claim 1, wherein a first side of the spring element facing the bimetal element faces the contact surface.

9. The temperature-dependent switch according to claim 8, wherein the spacer element projects in a first direction from the first side of the spring element and comprises a support surface on which the at least one section of the bimetal element is supported in the high-temperature state of the switching mechanism, wherein the support surface is oriented transversely to the first direction.

10. The temperature-dependent switch according to claim 1, wherein the spacer element is clamped in the switch housing by an interaction of the lower part and the cover part.

11. The temperature-dependent switch according to claim 1, wherein the spring element comprises between an outer edge and an inner area at least one compensating section, which enables a mechanical deformation of the spring element.

12. The temperature-dependent switch according to claim 1, wherein the movable contact part is fixed to the spring element.

13. The temperature-dependent switch according to claim 1, wherein the bimetal element is held captive but with play on the movable contact part.

14. The temperature-dependent switch according to claim 1, wherein the bimetal element and the spring element are each disc-shaped.

15. The temperature-dependent switch according to claim 1, wherein the movable contact part is mounted centrally on the spring element.

16. The temperature-dependent switch according to claim 1, wherein the first electrical terminal is arranged on an outside of the cover part and the second electrical terminal is arranged on an outside of the lower part.

17. The temperature-dependent switch according to claim 1, wherein the lower part comprises a free upper edge which is flanged or bent onto the cover part.
